(19) United States
(12) Patent Application Publication
(10) Pub. No.: US 2006/0055642 A1
(43) Pub. Date: Mar. 16, 2006

(54) LED display modules with pixel designs for enhanced visual quality of virtual pixels

(75) Inventors: Jason A. Daughenbaugh, Bozeman, MT (US); Bryan L. Robertus, Bozeman, MT (US)

Correspondence Address: DOCKET CLERK, P.O. DRAWER 800889, DALLAS, TX, 75380, US

(73) Assignee: BILLBOARD VIDEO, INC., Dallas, TX (US)

(21) Appl. No.: 11/165,567

(22) Filed: Jun. 23, 2005

Related U.S. Application Data
(60) Provisional application No. 60/610,291, filed on Sep. 16, 2004.

(51) Int. Cl. G09G 3/32

(52) U.S. Cl. 345/82

(57) ABSTRACT

An LED visual display apparatus includes a plurality of LED pixels arranged in a generally rectangular array and each having a substantially identical construction. A controller controls groups of the LEDs to produce virtual pixels. In some instances, the construction of each LED pixel consists of 6 to 9 LEDs, inclusive, includes a plurality of red LEDs, a plurality of green LEDs and at least one blue LED, and has more red LEDs than green LEDs. In some instances, the array includes rows of LEDs that consist only of green and blue LEDs which define a repeating green-green-blue pattern. In some instances, the array includes rows of LEDs that consist only of red and green LEDs which define a repeating red-red-green pattern.

This application claims the priority under 35 U.S.C. §119(e) of co-pending U.S. Provisional Application No. 60/610,291, filed on Sep. 16, 2004 and incorporated herein by reference.

### FIELD OF THE INVENTION

The invention relates generally to LED (light emitting diode) display modules and, more particularly, to pixel designs within LED display modules.

### BACKGROUND OF THE INVENTION

LED display modules are conventionally used in visual display applications, such as advertising billboards, stadium scoreboards, etc. A typical LED display module includes a generally rectangular array of LED pixels, each pixel including a plurality of LEDs positioned in a desired arrangement relative to one another. Conventional display modules can include, for example, 640 LEDs, and conventional billboards can include, for example, from 100 to as many as several thousand display modules.

FIGS. 1-6 (and corresponding color FIGS. 1A-6A) illustrate in plan view conventional examples of LED pixel structure designs. FIG. 1 illustrates an eight pixel-by-eight pixel portion of a rectangular array of LED pixels that can be provided on a display module. Each LED pixel P1 includes a red LED R, a green LED G, and a blue LED B. The pixel structure illustrated in FIG. 1 is a basic pattern with no resolution enhancement.

FIGS. 2-6 each illustrate four pixel-by-four pixel portions of generally rectangular LED pixel arrays. All pixels in a given array have the same LED pixel structure design. Each pixel P2 in FIG. 2 includes two red LEDs R1 and R2, a green LED G and a blue LED B. Each pixel P3 of FIG. 3 includes two red LEDs R1 and R2, two green LEDs G1 and G2, and a blue LED B. Each pixel P4 of FIG. 4 includes two red LEDs R1 and R2, two green LEDs G1 and G2, and two blue LEDs B1 and B2. Each pixel P5 of FIG. 5 includes four red LEDs R1-R4, four green LEDs G1-G4, and two blue LEDs B1 and B2. Each pixel P6 of FIG. 6 includes eight red LEDs R1-R8, four green LEDs G1-G4, and two blue LEDs B1 and B2.

Each of the pixel arrangements in FIGS. 2-6 has associated therewith a characteristic known as pitch, that is, the distance between the geometric centers of adjacent pixels (horizontally and vertically). Examples of typical pitch values in conventional arrangements include 25.4 mm, 38.1 mm and 50.8 mm. Resolution, brightness and other visual characteristics of the pixel arrangements of FIGS. 2-6 are determined by the pitch and by the various combinations of the number, color and placement of the LEDs within the individual pixel designs.

In FIGS. 2-6, the pixels P2-P6 are shown enclosed in dark-lined square boundary lines. These square boundary lines are shown to enclose a geometric area sufficient to accommodate sixteen conventional LEDs arranged in a four-by-four square array.

As illustrated at VP2 in FIG. 2, VP3 in FIG. 3, VP4 in FIG. 4, VP5 in FIG. 5 and VP6 in FIG. 6, it is known in the art to control the LEDs of an LED pixel array such that one or more LEDs from a single pixel is (are) shared by two or more “virtual pixels”. The centers of such virtual pixels are closer together than the centers of the “physical pixels” P2-P6. This creates a perceived pitch (or a virtual pitch) that is less than the actual physical pitch or distance between the centers of the physical pixels.

Taking as an example the virtual pixel boundary framework as conceptually illustrated at VP2 of FIG. 2, the virtual pixels defined by this boundary framework VP2 have a virtual pitch, illustrated diagrammatically at 200, that is substantially smaller than the physical pitch of the actual physical pixels P2, illustrated diagrammatically at 201. Each virtual pixel illustrated in FIG. 2 shares four LEDs with other neighboring virtual pixels. For example, the virtual pixel 20 shares four LEDs with eight virtual pixels 21-28 which immediately surround the virtual pixel 20. Each LED of a given physical pixel P2 in FIG. 2 is shared four ways among various virtual pixels. The virtual pixel boundary frameworks VP3-VP6 of FIGS. 3-6, respectively, illustrate other schemes for sharing LEDs to create virtual pixels whose virtual pitch is less than the physical pitch of the corresponding physical pixels P3-P6.

As mentioned above, the number, color and placement of LEDs within a physical pixel, together with the pitch of the pixel array, affect the various visual characteristics of the pixel array. When LED sharing is used to create virtual pixels as described above, the design of the physical pixels can affect virtual pixel design, and vice-versa.

It is therefore desirable to provide LED pixel arrays with pixel structure designs that produce desired visual quality and which may also be controlled to produce virtual pixels that provide a desired enhancement in visual quality.

### SUMMARY OF THE INVENTION

Exemplary embodiments of the present invention provide an LED visual display apparatus including a plurality of LED pixels that each have a substantially identical construction, including at least one each of red, green and blue LEDs. A support structure supports the LED pixels in a generally rectangular array. A controller controls groups of the LEDs to produce virtual pixels.

In some embodiments, the construction of each LED pixel consists of a number of LEDs in a range from 6 to 9, inclusive, includes a plurality of red LEDs, a plurality of green LEDs and at least one blue LED, and has more red LEDs than green LEDs.

In some embodiments, the generally rectangular array includes a plurality of rows of LEDs, and each of the rows consists only of green and blue LEDs that define a repeating pattern of three adjacent LEDs arranged such that a first green LED is followed by a second green LED adjacent to the first green LED, and the second green LED is followed by an adjacent blue LED.

In some embodiments, the generally rectangular array includes a plurality of rows of LEDs, and each of the rows consists only of red and green LEDs that define a repeating pattern of three adjacent LEDs arranged such that a first red LED is followed by a second red LED adjacent to the first red LED, and the second red LED is followed by an adjacent green LED.

Before undertaking the Detailed Description of the Invention, it may be advantageous to set forth a definition of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, coupled to or with, be communicable with, cooperate with, interleave, juxtapose, be proximate to, be bound to or with, have, have a property of, or the like; the term “memory” means any storage device, combination of storage devices, or part thereof whether centralized or distributed, whether locally or remotely; and the terms “controller,” “processor” and “allocator” mean any device, system or part thereof that controls at least one operation, such a device, system or part thereof may be implemented in hardware, firmware or software, or some combination of at least two of the same.

It should be noted that the functionality associated with any particular controller or allocator may be centralized or distributed, whether locally or remotely. In particular, a controller or allocator may comprise one or more data processors, and associated input/output devices and memory that execute one or more application programs and/or an operating system program.

Additional definitions for certain words and phrases are provided throughout this patent document, those of ordinary skill in the art should understand that in many, if not most instances, such definitions apply to prior uses, as well as to future uses, of such defined words and phrases.

### BRIEF DESCRIPTION OF THE DRAWINGS

For a more complete understanding of the present invention, and the advantages thereof, reference is now made to the following descriptions taken in conjunction with the accompanying drawings, wherein like numbers designate like objects, and in which:

FIG. 1 illustrates an LED pixel array according to the prior art.

FIGS. 2-6 illustrate various LED pixel arrays including virtual pixel arrays through LED sharing according to the prior art.

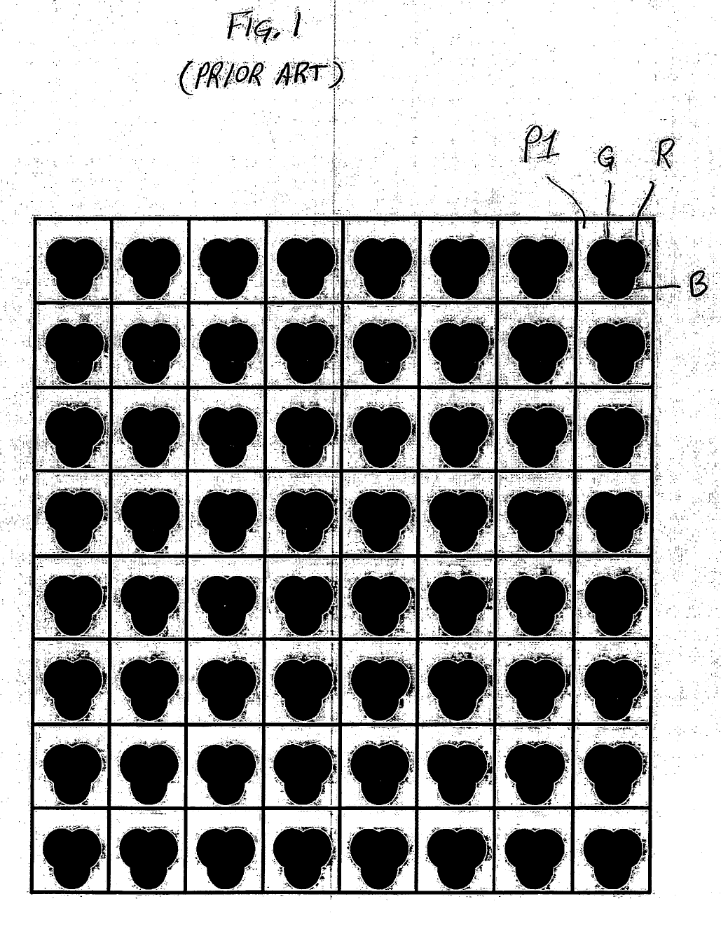

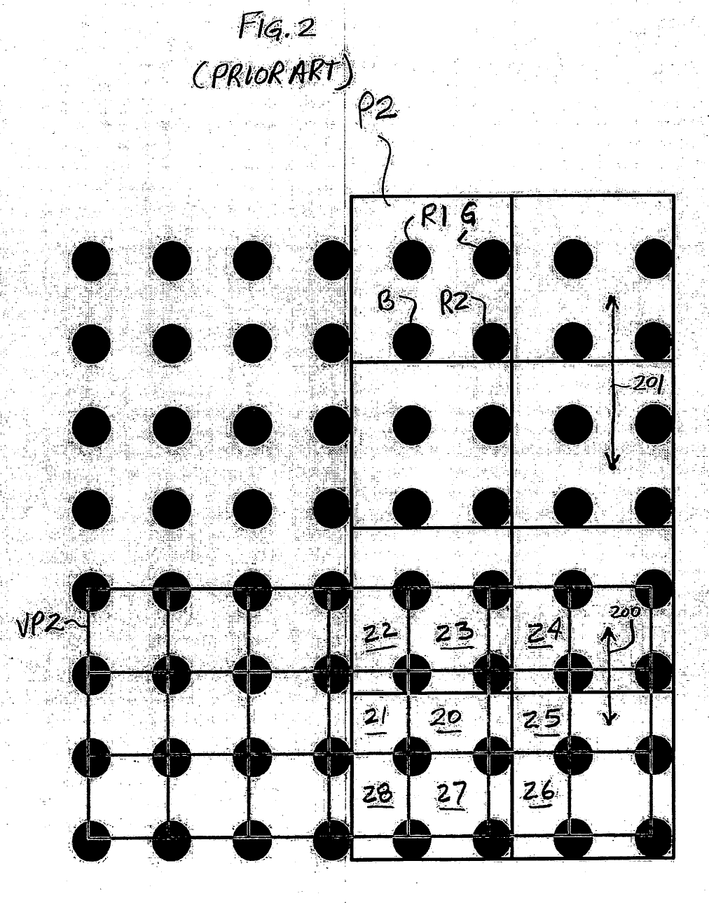

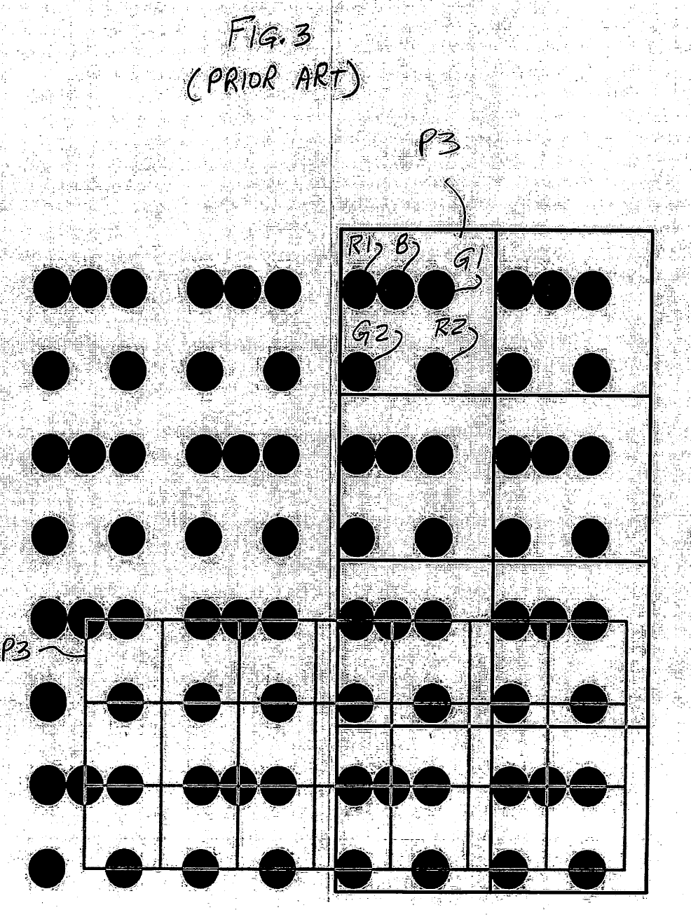

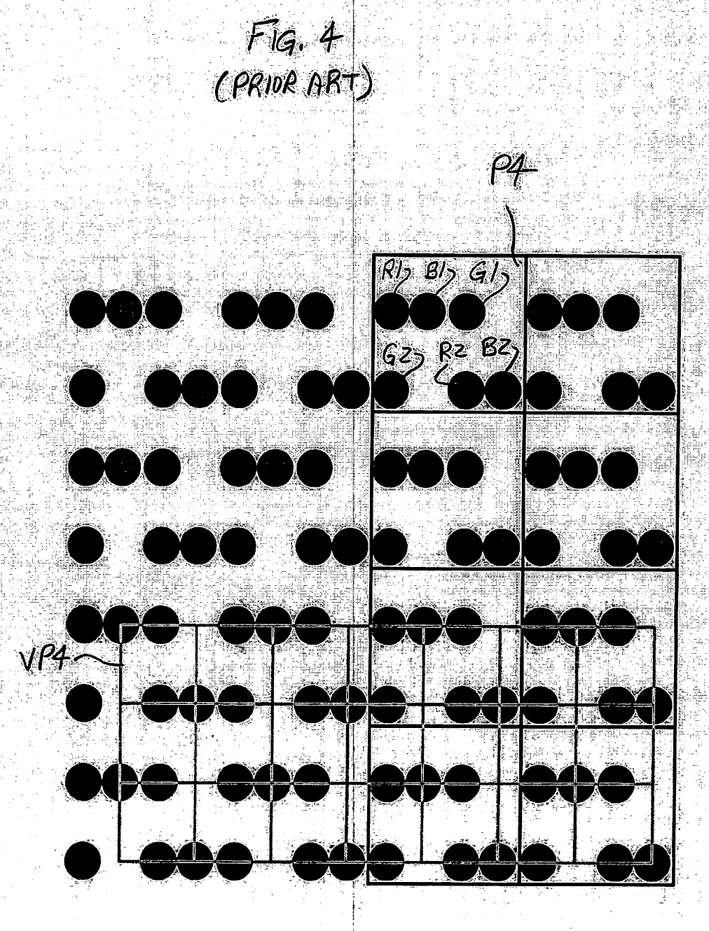

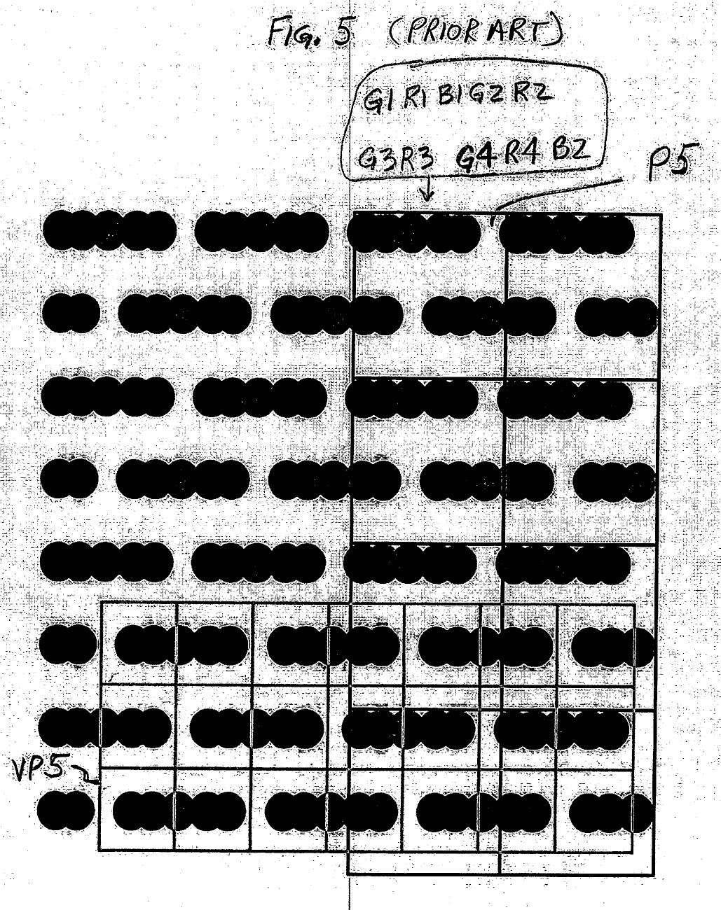

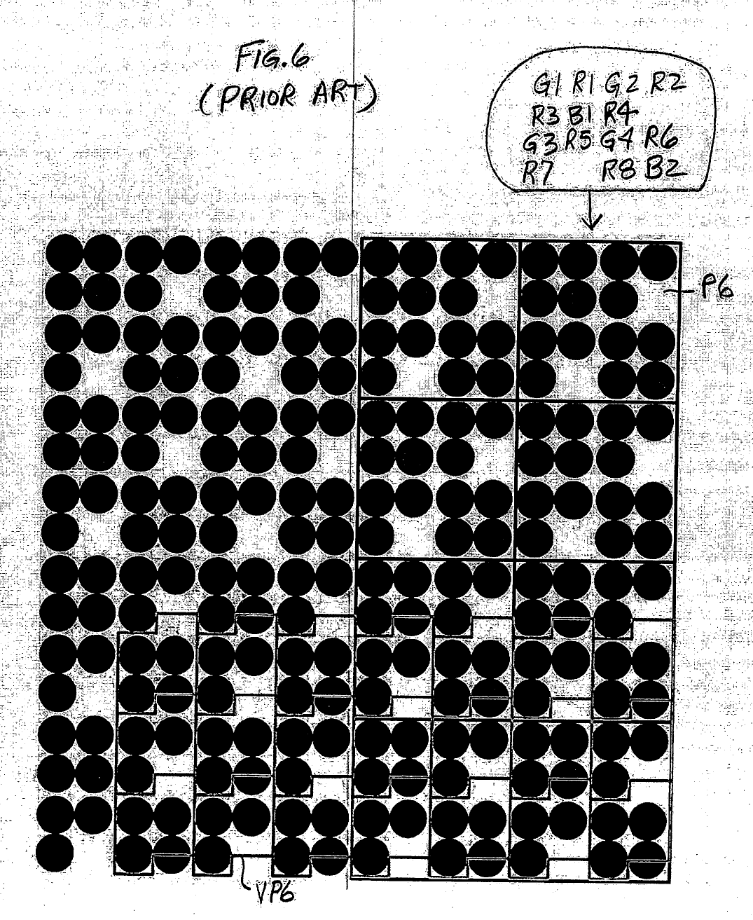

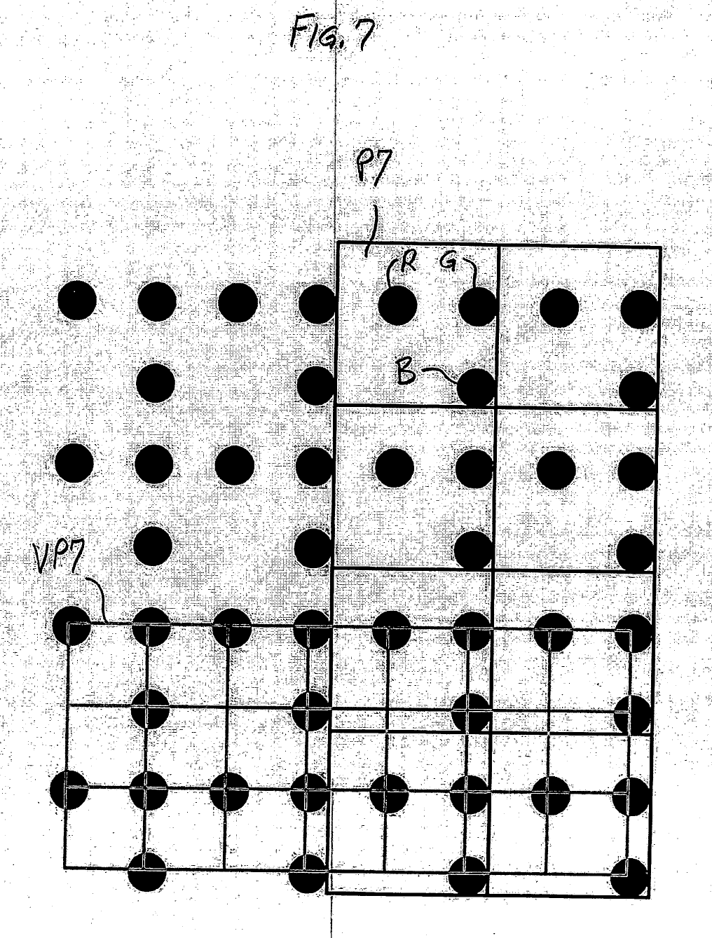

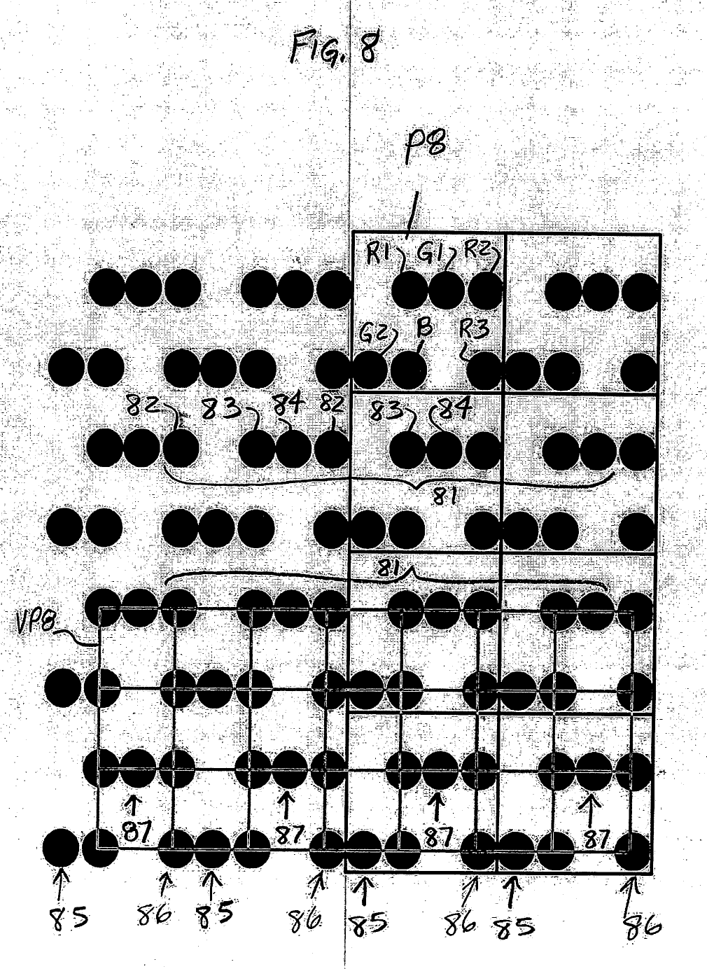

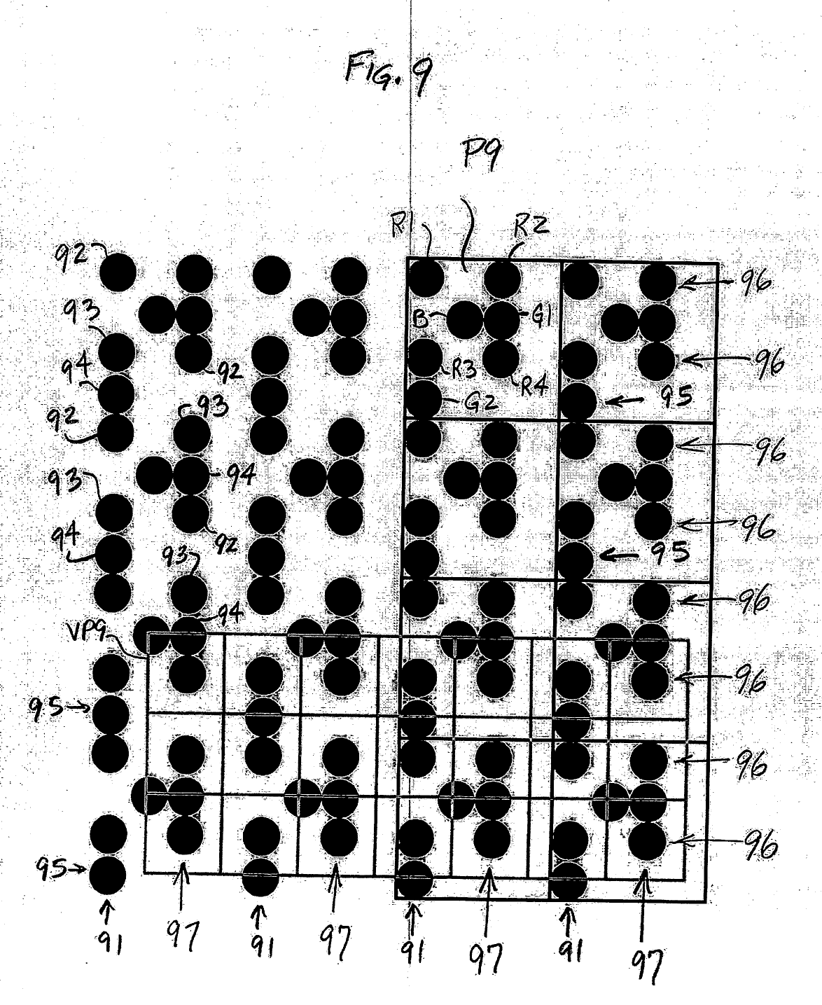

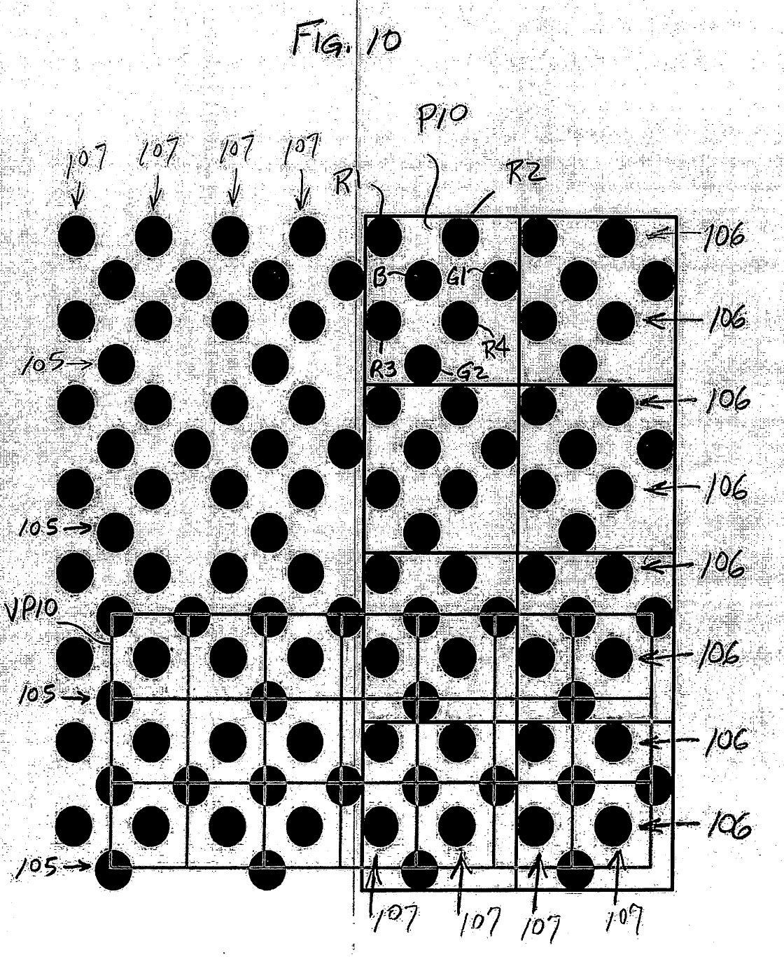

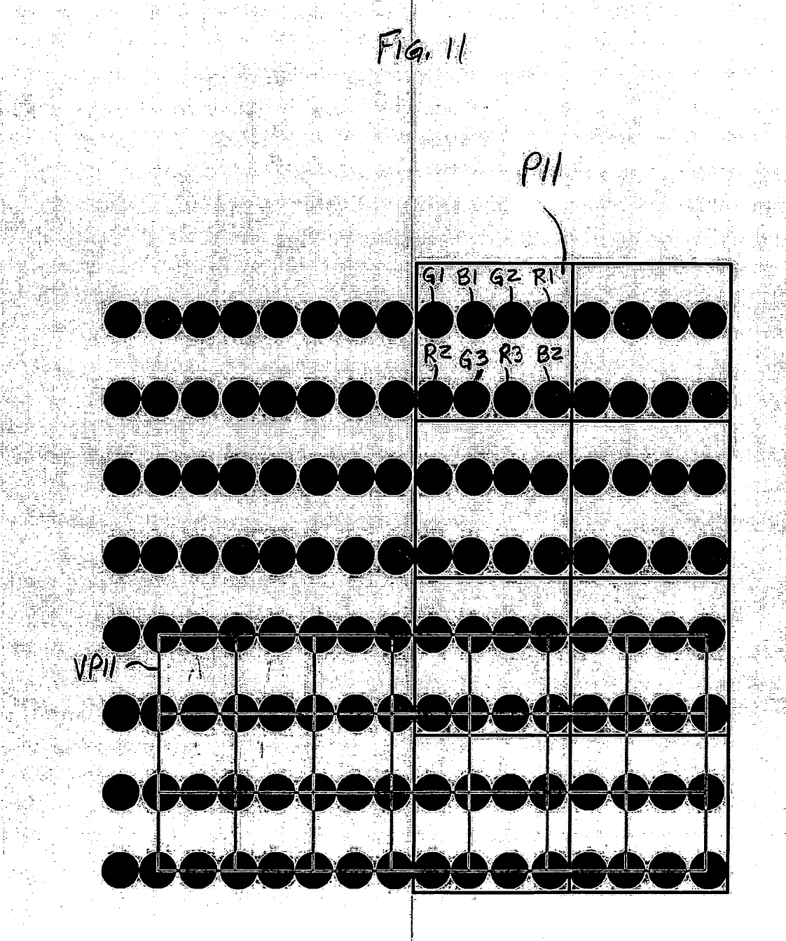

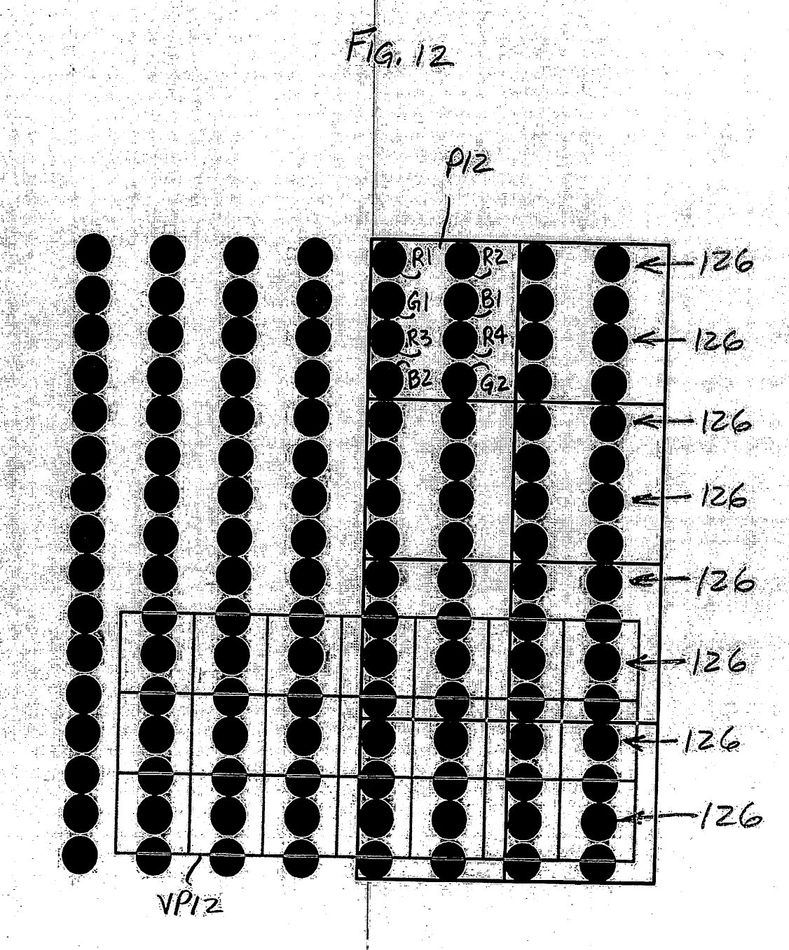

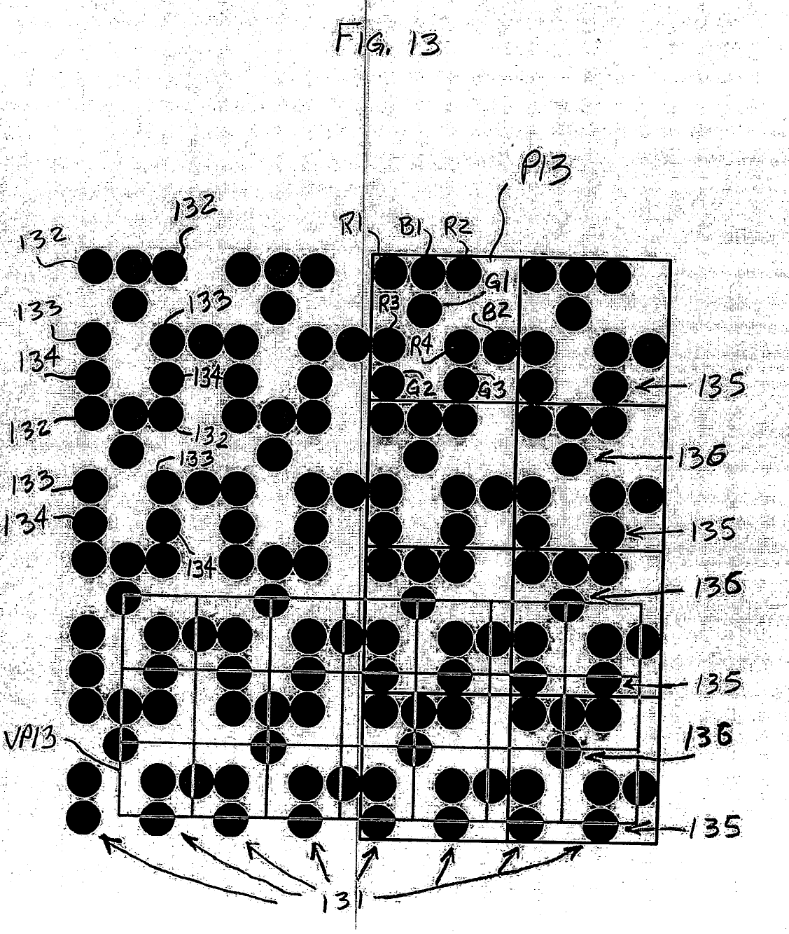

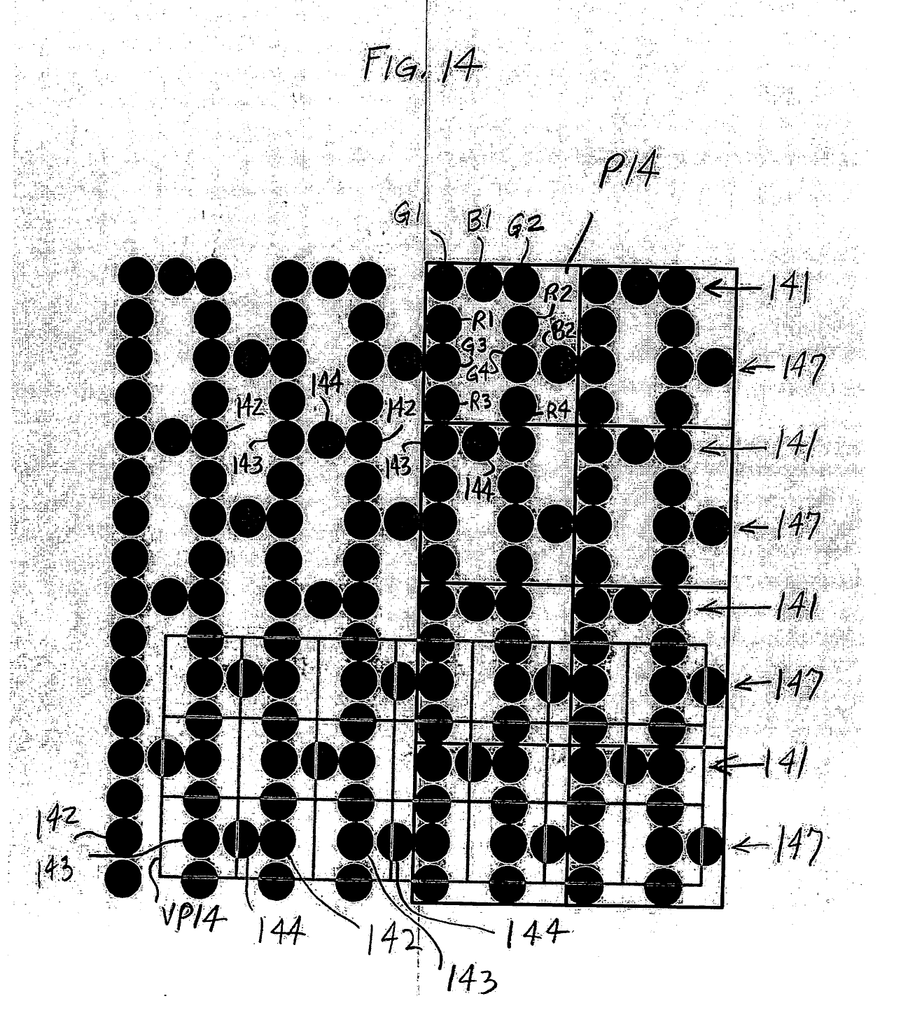

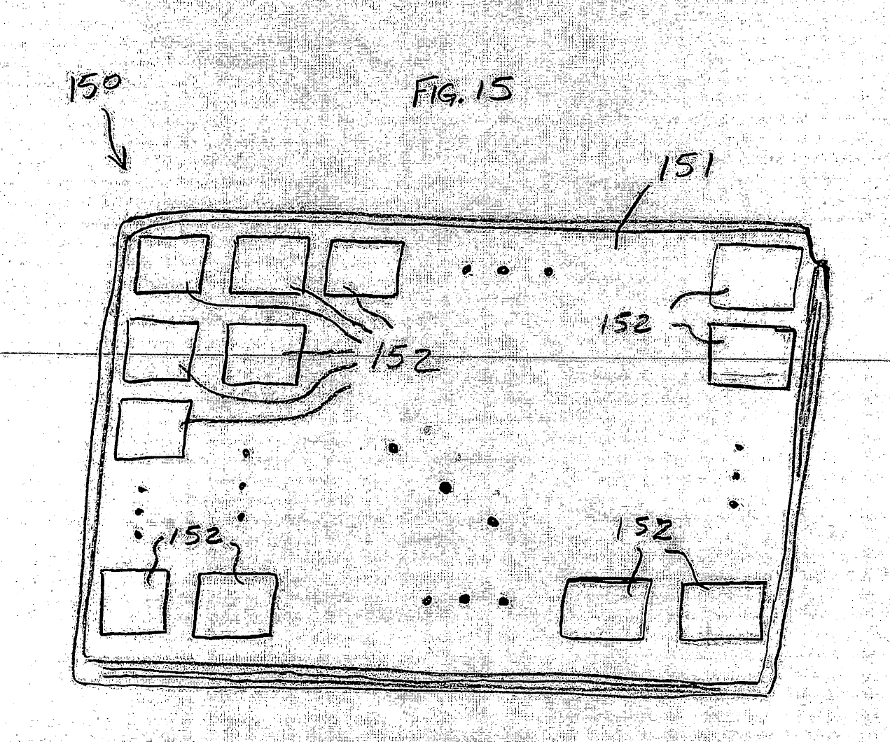

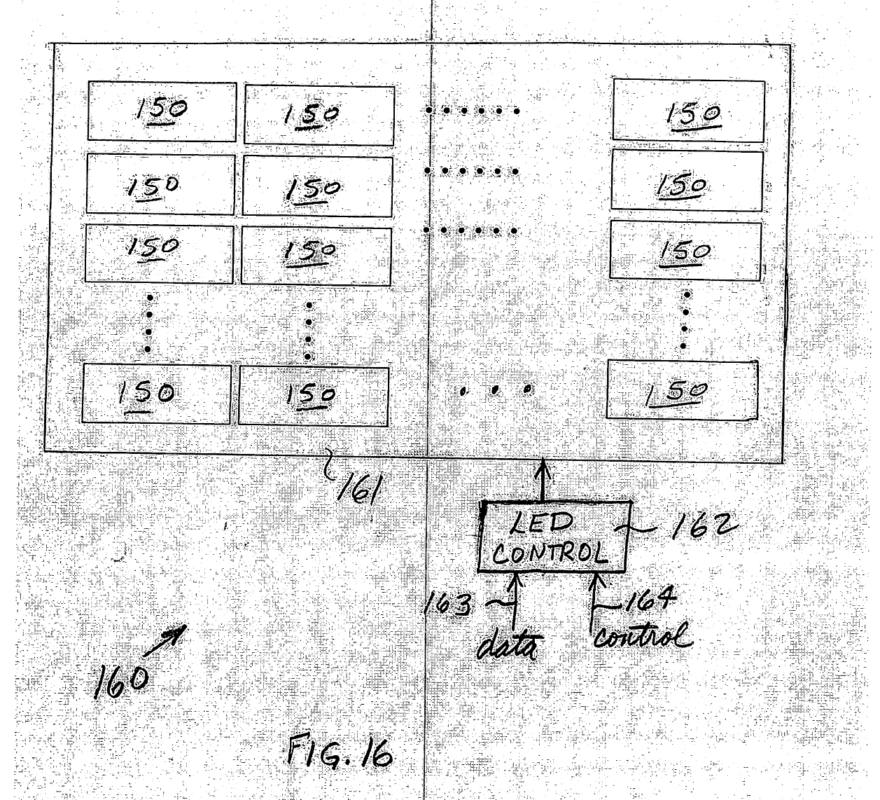

FIGS. 1A-6A are respective color versions of FIGS. 1-6.

FIGS. 7-14 illustrate LED pixel arrays including virtual pixel arrays through LED sharing according to various exemplary embodiments of the invention.

FIGS. 7A-14A are respective color versions of FIGS. 7-14.

FIG. 15 diagrammatically illustrates an LED display module according to exemplary embodiments of the invention.

FIG. 16 diagrammatically illustrates an LED billboard apparatus according to exemplary embodiments of the invention.

### DETAILED DESCRIPTION

FIGS. 1 through 16, discussed herein, and the various embodiments used to describe the principles of the present invention in this patent document, are by way of illustration only and should not be construed in any way to limit the scope of the invention. Those skilled in the art will understand that the principles of the present invention may be implemented in any suitably arranged LED sign apparatus.

FIGS. 7-14 (and corresponding color FIGS. 7A-14A) illustrate portions of generally rectangular LED pixel arrays that include corresponding virtual pixel arrays through LED sharing according to various exemplary embodiments of the invention. In any given one of FIGS. 7-14, the illustrated pixel array portion is a four pixel-by-four pixel square, and each of the pixels has the same LED arrangement.

In FIG. 7, pixel P7 in the array includes basically the same red, green and blue LEDs as in the basic arrangement of prior art FIG. 1. However, due to the positioning of the LEDs, it is possible to display a higher resolution than when, as in FIG. 1, the red, green and blue LEDs are clustered as a triplet and mapped as a single point. The virtual pixel boundary framework VP7 illustrates the definition of virtual pixels through LED sharing. In the example of FIG. 7, each of the red, green and blue LEDs of a given pixel is shared among four virtual pixels as illustrated by the virtual pixel boundary framework VP7. The example of FIG. 7 exhibits a resolution enhancement factor (REF) of 1.35. The REF quantifies the perceived image enhancement provided by the virtual pixel array. If REF=1, there is no resolution enhancement, and the virtual pitch is equal to the physical pitch. If REF=2, this is the maximum possible resolution enhancement, and the virtual pitch is half of the physical pitch, meaning that the virtual resolution is twice the physical resolution.

Each pixel P8 in the array of FIG. 8 includes three red LEDs R1-R3, two green LEDs G1 and G2, and one blue LED B, arranged as shown. The virtual pixel boundary framework VP8 shows that, for a given pixel, each of the red and blue LEDs is shared by four virtual pixels, and each green LED is shared by two virtual pixels. For the embodiment of FIG. 8, REF=1.75.

In the arrangement of FIG. 9, each pixel P9 includes four red LEDs R1-R4, two green LEDs G1 and G2, and one blue LED B, arranged as shown. The virtual pixel boundary framework VP9 shows that, for a given pixel, each red LED is located generally at the center of a corresponding virtual pixel and is not shared between virtual pixels, each blue LED is shared by four virtual pixels, and each green LED is shared by two virtual pixels. In the embodiment of FIG. 9, REF=1.85.

Each pixel P10 in the array of FIG. 10 includes four red LEDs R1-R4, two green LEDs G1 and G2, and one blue LED B, arranged as shown. The virtual pixel boundary framework VP10 shows that, for a given pixel, each red LED is located generally at the center of a corresponding virtual pixel and is not shared by virtual pixels, and that each of the green and blue LEDs is shared by four virtual pixels. In the embodiment of FIG. 10, REF=1.85.

Each pixel P11 in the array of FIG. 11 includes three red LEDs R1-R3, three green LEDs G1-G3, and two blue LEDs B1 and B2, arranged as shown. The virtual pixel boundary framework VP11 shows that, for a given pixel, the red LEDs R2 and R3, and the green LEDs G1 and G2 are shared by two virtual pixels, and that each of the remaining LEDs R1, G3, B1 and B2 is shared by four virtual pixels. In the embodiment of FIG. 11, REF=1.8.

Each pixel P12 in the array of FIG. 12 includes four red LEDs R1-R4, two green LEDs G1 and G2, and two blue LEDs B1 and B2, arranged as shown. The virtual pixel boundary framework VP12 shows that, for a given pixel, each of the red LEDs R1-R4 is located generally at the center of a corresponding virtual pixel and is not shared by virtual pixels, and that each of the remaining LEDs G1, G2, B1, and B2 is shared by two virtual pixels. In the embodiment of FIG. 12, REF=1.9.

Each pixel P13 in the array of FIG. 13 includes four red LEDs R1-R4, three green LEDs G1-G3 and two blue LEDs B1 and B2, arranged as shown. The virtual pixel boundary framework VP13 shows that, for a given pixel, each of the red LEDs R1-R4 is located generally at the center of a corresponding virtual pixel and is not shared by virtual pixels, blue LEDs B1 and B2 and green LEDs G2 and G3 are each shared by two virtual pixels, and green LED G1 is shared by four virtual pixels. In the embodiment of FIG. 13, REF=1.8.

Each pixel P14 in the array of FIG. 14 includes four red LEDs R1-R4, four green LEDs G1-G4, and two blue LEDs B1 and B2, arranged as shown. The virtual pixel boundary framework VP14 shows that, for a given pixel, each green LED is located generally at the center of a virtual pixel, each red LED is shared by two virtual pixels, and each blue LED is shared by two virtual pixels. In the embodiment of FIG. 14, REF=2.0.

Referring again to the embodiments of FIGS. 8, 9 and 13, each of these embodiments includes a plurality of rows of LEDs that define a repeating red-red-green pattern. This can be seen in the LED rows 81 extending left-to-right in FIG. 8, in the LED rows 91 and 97 extending from top-to-bottom in FIG. 9, and in the LED rows 131 extending from top-to-bottom in FIG. 13. In each of these embodiments, the aforementioned red-red-green pattern is repeated along the row, and the pattern is defined by sets of three consecutively adjacent LEDs. In this context, any two LEDs are considered to be adjacent in a given row if there is no other LED interposed between those two LEDs. The red-red-green pattern is illustrated at 82-84 in FIG. 8, at 92-94 in FIG. 9, and at 132-134 in FIG. 13. Note that in FIGS. 9 and 13 there are two red-red-green rows in each top-to-bottom LED pixel row.

The embodiment of FIG. 14 includes a plurality of rows of LEDs that define a repeating green-green-blue pattern that is generally similar to the red-red-green pattern described above with respect to FIGS. 8, 9 and 13. This green-green-blue pattern can be seen in the LED rows 141 and 147 extending left-to-right in FIG. 14. The green-green-blue pattern is repeated along the row, and the pattern is defined by sets of three consecutively adjacent LEDs. As described above, any two LEDs are considered to be adjacent in a given row if there is no other LED interposed between those two LEDs. The green-green-blue pattern is illustrated at 142-144 in FIG. 14. Note that there are two green-green-blue rows (141 and 147) in each left-to-right LED pixel row of FIG. 14.

The embodiments of FIGS. 8, 9, 10 and 13 each include rows that consist only of green LEDs. Examples of all green LED rows are indicated at 95 and 105 in FIGS. 9 and 10, respectively. Two different all green LED rows are shown at 85 and 87 in FIG. 8, and at 135 and 136 in FIG. 13.

In each of the embodiments of FIGS. 8, 9, 10, 12 and 13, the LED pixel construction includes more red LEDs than green LEDs. The LED pixels P8 of FIG. 8 each include six LEDs, three of which are red and two of which are green. The LED pixels P9 of FIG. 9 each include seven LEDs, four of which are red and two of which are green. The LED pixels P10 of FIG. 10 each include seven LEDs, four of which are red and two of which are green. The LED pixels P12 of FIG. 12 each include eight LEDs, four of which are red and two of which are green. The LED pixels P13 of FIG. 13 each include nine LEDs, four of which are red and three of which are green.

The embodiments of FIGS. 8, 9, 10 and 12 include rows that consist entirely of red LEDs. Examples of such all red LED rows are illustrated at 86, 96, 106 and 126 in FIGS. 8, 9, 10 and 12, respectively. In addition, the embodiment of FIG. 10 includes all red LED rows extending in both the left-to-right and the top-to-bottom directions. The top-to-bottom all red LED rows in FIG. 10 are designated at 107.

FIG. 15 diagrammatically illustrates an LED display module according to exemplary embodiments of the invention. The LED display module 150 includes a support panel 151 which supports thereon a plurality of LED pixels 152 arranged in a generally rectangular array. In various embodiments, the LED pixel structure illustrated generally at 152 can be any one of the LED pixel structure designs illustrated at P7-P14 in FIGS. 7-14, respectively.

FIG. 16 diagrammatically illustrates an LED billboard apparatus according to exemplary embodiments of the invention. The LED billboard 160 includes a plurality of LED display modules 150, such as described above with respect to FIG. 15. A billboard structure 161 supports the LED display modules 150 in a generally rectangular array. Other embodiments support the display modules 150 in other array shapes. An LED control system 162 is coupled to the LEDs of the LED display modules 150, and is responsive to data and control inputs 163 and 164 for controlling operation of the LEDs in the various LED display modules. The LED control system 162 can control the LEDs appropriately to implement virtual pixel arrays such as those described above.

The foregoing has outlined the features and technical advantages of the present invention so that those skilled in the art may understand the invention. Those skilled in the art should appreciate that they may readily use the conception and the specific embodiments disclosed as a basis for modifying or designing other structures for carrying out the same purposes of the present invention. Those skilled in the art should also realize that such equivalent constructions do not depart from the spirit and scope of the invention in its broadest form.

What is claimed is:

1. An LED visual display apparatus, comprising:
a plurality of LED pixels, each of said LED pixels having a substantially identical construction;
a support structure which supports said LED pixels as a generally rectangular array of LED pixels;
said construction consisting of a number of LEDs in a range from six to nine, inclusive, said construction including a plurality of red LEDs, a plurality of green LEDs, and at least one blue LED, and said construction having more of said red LEDs than said green LEDs; and
a controller coupled to said LEDs, said controller controlling groups of said LEDs to produce corresponding virtual LED pixels defined respectively by said groups of LEDs, each said virtual LED pixel including at least one said LED of a corresponding one of said LED pixels but less than all of said LEDs of said corresponding LED pixel.

2. The apparatus of claim 1, wherein said generally rectangular array is defined by first and second directions which are generally perpendicular to one another, said generally rectangular array including a plurality of rows of said LED pixels, each said row of LED pixels extending across substantially all of said array in one of said first and second directions and including a respectively corresponding row of said LEDs extending in said one direction across substantially all of said array, each said row of LEDs consisting of only green LEDs.

3. The apparatus of claim 2, wherein said generally rectangular array includes a further plurality of rows of said LED pixels, each said row of said further plurality extending in one of said first and second directions across substantially all of said array and including a respectively corresponding row of LEDs extending in said one direction across substantially all of said array, each of said last-mentioned rows of LEDs consisting of only red and green LEDs arranged to define a pattern which extends along said one direction associated with said further plurality and is repeated throughout said row of LEDS, said pattern consisting of three adjacent LEDs, wherein a first red LED of said pattern is followed in said one direction associated with said further plurality by an adjacent second red LED of said pattern, and said second red LED is followed in said one direction associated with said further plurality by an adjacent green LED of said pattern.

4. The apparatus of claim 3, wherein said first-mentioned rows of LEDs extend in said first direction and said last-mentioned rows of LEDs extend in said second direction.

5. The apparatus of claim 2, wherein said generally rectangular array includes a further plurality of rows of said LED pixels, each said row of said further plurality extending in one of said first and second directions across substantially all of said array and including a respectively corresponding row of LEDs extending in said one direction across substantially all of said array, each of said last-mentioned rows of LEDs consisting only of red LEDs.

6. The apparatus of claim 5, wherein all of said rows of LEDS extend in said first direction.

7. The apparatus of claim 5, wherein said generally rectangular array includes a still further plurality of rows of said LED pixels which extend in one of said first and second directions across substantially all of said array and which each include a respectively corresponding row of LEDs extending in said one direction across substantially all of said array, each of said last-mentioned rows of LEDs consisting only of red LEDs.

8. The apparatus of claim 7, wherein all of said rows of LEDs extend in said first direction.

9. The apparatus of claim 5, wherein said generally rectangular array includes a still further plurality of rows of said LED pixels which extend in one of said first and second directions across substantially all of said array and which each include a respectively corresponding row of LEDs extending in said one direction across substantially all of said array, each of said last-mentioned rows of LEDs consisting of only red and green LEDs arranged to define a pattern which extends along said one direction associated with said still further plurality and is repeated throughout said row of LEDs, said pattern consisting of three adjacent LEDs, wherein a first red LED of said pattern is followed in said one direction associated with said still further plurality by an adjacent second red LED of said pattern, and said second red LED is followed in said one direction associated with said still further plurality by an adjacent green LED of said pattern.

10. The apparatus of claim 9, wherein said last-mentioned rows of LEDs extend in said second direction and one of said first-mentioned rows of LEDs and said second-mentioned rows of LEDs extend in said first direction.

11. The apparatus of claim 10, wherein both said first-mentioned rows of LEDs and said second-mentioned rows of LEDs extend in said first direction.

12. The apparatus of claim 1, wherein said generally rectangular array includes a plurality of rows of said LED pixels which extend in one of said first and second directions across substantially all of said array and which each include a respectively corresponding row of LEDs extending in said one direction across substantially all of said array, each of said rows of LEDs consisting only of red and green LEDs arranged to define a pattern which extends along said one direction and is repeated throughout said row of LEDs, said pattern consisting of three adjacent LEDs, wherein a first red LED of said pattern is followed in said one direction by an adjacent second red LED of said pattern, and said second red LED is followed in said one direction by an adjacent green LED of said pattern.

13. The apparatus of claim 1, wherein each said virtual LED pixel shares at least one of said LEDs thereof with another said virtual LED pixel, and, within each said virtual LED pixel, said at least one LED of said corresponding LED pixel including a red LED that is not shared with any other said virtual LED pixel.

14. An LED visual display apparatus, comprising:
a plurality of LED pixels, each of said LED pixels having a substantially identical construction including at least one each of red, green and blue LEDs;
a support structure which supports said LED pixels as a generally rectangular array of LED pixels;
said generally rectangular array defined by first and second directions which are generally perpendicular to one another, said generally rectangular array including a plurality of rows of said LED pixels, each said row of LED pixels extending in one of said directions across substantially all of said array and including a respectively corresponding row of LEDs extending in said one direction across substantially all of said array, each said row of LEDs consisting of only blue and green LEDs arranged to define a pattern which extends along said one direction and is repeated throughout said row of LEDs, said pattern consisting of three adjacent LEDs, wherein a first green LED of said pattern is followed in said one direction by an adjacent second green LED of said pattern, and said second green LED is followed in said one direction by an adjacent blue LED of said pattern; and
a controller coupled to said LEDs, said controller controlling groups of said LEDs to produce corresponding virtual LED pixels defined respectively by said groups of LEDs, each said virtual LED pixel including at least one said LED of a corresponding one of said LED pixels but less than all of said LEDs of said corresponding LED pixel.

15. The apparatus of claim 14, wherein said generally rectangular array includes a further plurality of rows of said LED pixels which extend in one of said first and second directions across substantially all of said array and which each include a respectively corresponding row of LEDs extending in said one direction across substantially all of said array, each of said last-mentioned rows of LEDs consisting of only red LEDs.

16. The apparatus of claim 15, wherein both said first-mentioned rows of LEDs and said second-mentioned rows of LEDs extend in said first direction.

17. The apparatus of claim 14, wherein each said virtual LED pixel shares at least one of said LEDs thereof with another said virtual LED pixel, and, within each said virtual LED pixel, said at least one LED of said corresponding LED pixel including a green LED that is not shared with any other said virtual LED pixel.

18. An LED visual display apparatus, comprising:
a plurality of LED pixels, each of said LED pixels having a substantially identical construction including at least one each of red, green and blue LEDs;
a support structure which supports said LED pixels as a generally rectangular array of pixels;
said generally rectangular array defined by first and second directions which are generally perpendicular to one another, said generally rectangular array including a plurality of rows of said LED pixels, each said row of LED pixels extending in one of said directions across substantially all of said array and including a respectively corresponding row of LEDs extending in said one direction across substantially all of said array, each said row of LEDs consisting of only red and green LEDs arranged to define a pattern which extends along said one direction and is repeated throughout said row of LEDs, said pattern consisting of three adjacent LEDs, wherein a first red LED of said pattern is followed in said one direction by an adjacent second red LED of said pattern, and said second red LED is followed in said one direction by an adjacent green LED of said pattern; and
a controller coupled to said LEDs, said controller controlling groups of said LEDs to produce corresponding virtual LED pixels defined respectively by said groups of LEDs, each said virtual LED pixel including at least one said LED of a corresponding one of said LED pixels but less than all of said LEDs of said corresponding LED pixel.

19. The apparatus of claim 18, wherein each said row of LED pixels includes a respectively corresponding further row of LEDs extending in said one direction across substantially all of said array and consisting only of red and green LEDs arranged to define said pattern.

20. The apparatus of claim 18, wherein each said virtual LED pixel shares at least one of said LEDs thereof with another said virtual LED pixel, and, within each said virtual LED pixel, said at least one LED of said corresponding LED pixel including a red LED that is not shared with any other said virtual LED pixel.
